(19) United States
(12) Patent Application Publication
(10) Pub. No.: US 2014/0287802 A1
(43) Pub. Date: Sep. 25, 2014

(54) PHONE CASE WITH WIND FILTER

(71) Applicant: American Builder, LLC, Westford, MA (US)

(72) Inventors: Robert A. Walker, Westford, MA (US); Brian Gurry, Andover, MA (US)

(73) Assignee: American Builder, LLC, Westford, MA (US)

(21) Appl. No.: 14/083,490

(22) Filed: Nov. 19, 2013

Related U.S. Application Data
(60) Provisional application No. 61/805,004, filed on Mar. 25, 2013.

(51) Int. Cl. H04M 1/02

(52) U.S. Cl. CPC H04M 1/026
USPC 455/575.1

(57) ABSTRACT

A case for a handheld wireless device has a case body adapted to receive a handheld wireless device having a microphone. The case has a filter compartment defined by a plurality of walls of the case body and positioned adjacent to the microphone when the handheld wireless device is received in the case body. A sound filter is disposed in the filter compartment and configured to reduce sound received by the microphone opening due to moving air.

### BACKGROUND OF THE INVENTION

1. Field of the Invention

The present invention relates generally to accessories for wireless telephones and more particularly to a protective case for use with a wireless phone.

2. Description of the Prior Art

Wireless phones, and more specifically cell phones, typically have a rigid housing with openings in the housing for speakers and microphones. Apple's iPhone 4 and Samsung's Galaxy S4 phone, for example, each have a flat, rectangular housing with rounded corners. The bottom end of the housing has a microphone opening for the phone's built-in microphone. During a phone call, the user's voice and other sounds are detected by the built-in microphone located just behind the opening. The microphone opening of some phones includes a very thin (about 0.005″) solid or perforated screen, such as a fabric or wire mesh, that prevents debris and moisture from entering the opening and damaging the microphone.

### SUMMARY OF THE INVENTION

A problem with wireless phones and other handheld devices is that the user often uses the device outside in breezy conditions. Even when the device includes a thin protective mesh over the microphone opening, the device's built-in microphone also picks up the sound of air moving across the microphone opening (e.g., wind, breeze, the user's breath) and/or against the microphone itself. This is because the protective mesh is far too thin to effectively break up the sound of moving air. As a result, moving air is picked up by the built-in microphone and transmitted to the call recipient or recorded as a harsh sound similar to static or white noise. This sound often overwhelms other sounds, including the user's voice.

In some situations, the sound of moving air is a short-lived distraction during a phone call or audio/video recording. In other situations, the sound of moving air is so frequent, long lasting, or uncontrollable that the user cannot tolerate to continue the call or recording. To prevent the microphone from picking up the sound of moving air, the user may attempt to shield the microphone from the moving air with his free hand or the user can move to a less breezy environment. When using a phone or other device outside in swirling breezes or in a convertible car, however, the user cannot effectively shield the microphone from the moving air. The nearly incessant sound of moving air leaves the user no option but to terminate the call or recording until he can locate a less breezy environment in which to continue.

Although manufacturers of devices and related accessories have developed cases to protect the device's display screen, buttons, and other features, no built-in device feature or after-market accessory has addressed the problem of moving air being picked up by the device's built-in microphone. Accordingly, a need exists for an effective moving air sound filter that is adapted for handheld wireless devices or their cases.

It is an object of the present invention to improve user satisfaction while using a handheld wireless device in breezy environments.

It is another object of the present invention to reduce the sound of moving air picked up by the built-in microphone of a handheld wireless device.

The present invention achieves these and other objectives by providing a case for handheld wireless devices where the case has a filter disposed in one or more filter compartments of the case. In one aspect of the present invention, a case has a case body defining a device well adapted to receive the handheld wireless device, where the handheld wireless device has a microphone and a device lower end portion. A filter compartment is defined by a plurality of walls of the case body and positioned to be adjacent to the microphone when the handheld wireless device is received in the device well. A sound filter is disposed in the filter compartment and configured to reduce sound received by the microphone due to moving air.

In another embodiment, the filter compartment is adjacent the device lower end portion and the moving air sound filter is configured to abut the handheld wireless device proximate to the microphone.

In another embodiment, the sound filter comprises open-cell foam and/or reticulated foam.

In another embodiment, the sound filter has a thickness of at least ¼″ between the microphone and the ambient air.

In another embodiment, the sound filter is retained in the filter compartment by being compressed between the plurality of walls of the case body.

In another aspect of the present invention, a case for a handheld wireless device includes a case upper end portion, a case lower end portion, and a body with a plurality of walls extending substantially perpendicularly from the body. The case defines a device well adapted to receive a handheld wireless device that has a microphone in or on a device lower end portion. A filter compartment defined by the case lower end portion communicates with the device well. A sound filter is disposed in the filter compartment and is configured to abut the device lower end portion to reduce the microphone from receiving sound caused by moving air.

In another aspect of the present invention, a kit includes a case configured to receive a handheld wireless device and at least one sound filter configured to be disposed in a filter compartment of the case to reduce sound interference received by the microphone due to moving air.

### BRIEF DESCRIPTION OF THE DRAWINGS

FIG. 1 illustrates a front, perspective view of one embodiment of a case of the present invention showing sound filters disposed in a lower end portion.

FIG. 2 illustrates a rear elevation of the case of FIG. 1

FIG. 3 illustrates a front elevation of the case of FIG. 1

FIG. 4 illustrates a bottom perspective view of the case of FIG. 1

FIG. 5 illustrates a bottom perspective view of another embodiment of a case of the present invention and shows the lower end portion.

FIG. 6 illustrates an upper end perspective view of the case of FIG. 1

FIG. 7 illustrates a rear perspective view of the case of FIG. 1

FIG. 8 illustrates a right side elevation of the case of FIG. 1

FIG. 9 illustrates a front elevation of the case of FIG. 1 shown with a handheld wireless device received in the case with the device end portion in the lower end portion of the case.

FIG. 10 illustrates a front perspective view of a portion of a handheld wireless device showing a device lower end portion with a microphone or microphone opening and a speaker.

### DETAILED DESCRIPTION OF THE PREFERRED EMBODIMENT

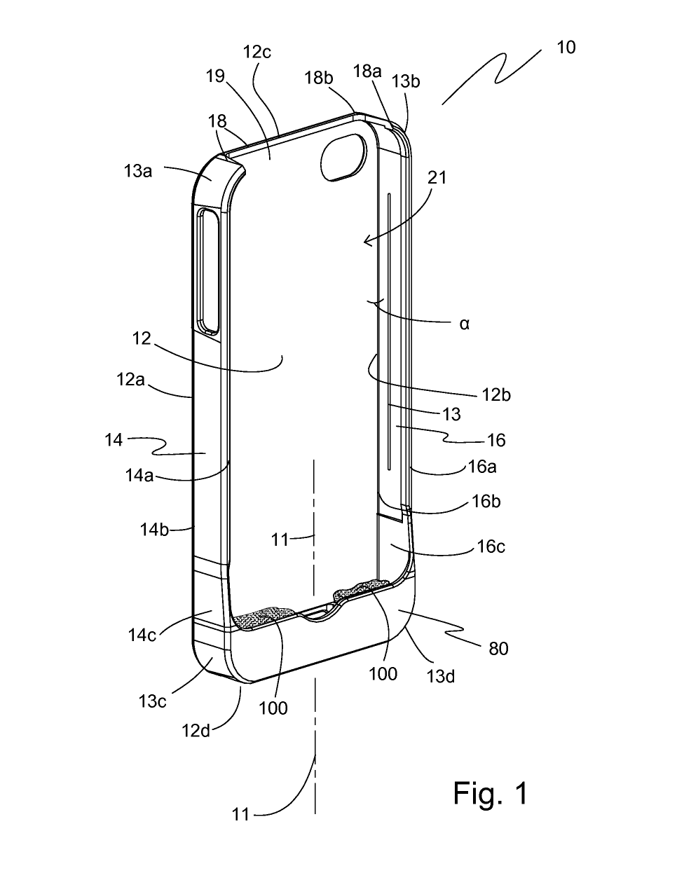

The preferred embodiments of the present invention are illustrated in FIGS. 1-10. FIG. 1 illustrates a front perspective view of one embodiment of a phone case 10 with a moving air sound filter or sound filter 100 disposed within a lower end 80. Case 10 has a substantially planar case body 12 extending along a central longitudinal axis 11. Case body 12 has a generally rectangular shape with a first edge 12a, a second edge 12b, an upper edge 12c, and a lower edge 12d. A first sidewall 14 extends substantially parallel to central longitudinal axis 11 and has a top margin 14a, a bottom margin 14b, and a lower first sidewall portion 14c. Bottom margin 14b of first sidewall 14 extends along and connects to first edge 12a of case body 12. A second sidewall 16 positioned opposite of first sidewall 14 and also substantially parallel to central longitudinal axis 11 has a top margin 16a, a bottom margin 16b, and a lower second sidewall portion 16c. Bottom margin 16c of second sidewall 16 extends along and connects to second edge 12b of case body 12. An upper end wall 18 has a top margin 18a and a bottom margin 18b. Optional rounded corners 13a, 13b, 13c, 13d may be used to join neighboring sidewalls 14, 16, 18, 20. Case body 12 and walls 14, 16, 18, 20 define a device well 21 that is sized and configured to receive a handheld wireless device 2, such as a phone.

In one embodiment, first sidewall 14 and second sidewall 16 define an angle α of about ninety degrees with case body 12. In other embodiments, angle α is greater or less than ninety degrees and is selected based on the profile of the phone for which case 10 is intended and for ease of installing case 10 on handheld wireless device 2.

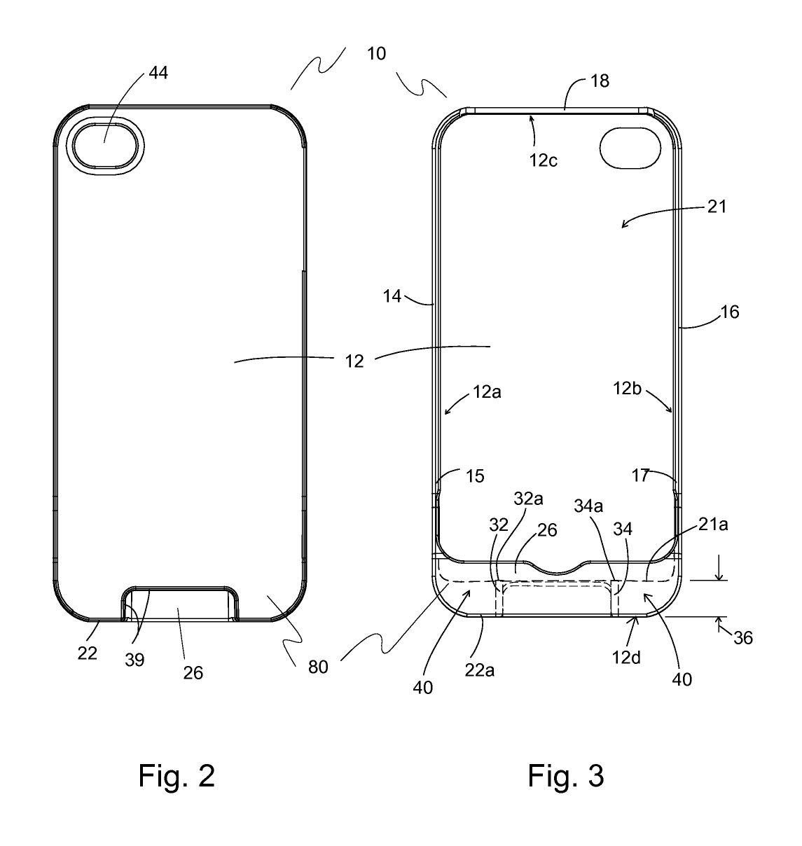

FIG. 2 illustrates a rear plan view of case 10 and shows lower end portion 80 with a back cutout 39 through case body 12 and lower end wall 22. Case body 12 has one or more optional openings 44 for cameras or other features of handheld wireless device 2. Back cutout 39 is preferably concealed by front panel member 26 when case 10 is viewed from its front side as shown in a front view of FIG. 3. Back cutout 39 allows access to a connector opening 28 as discussed below.

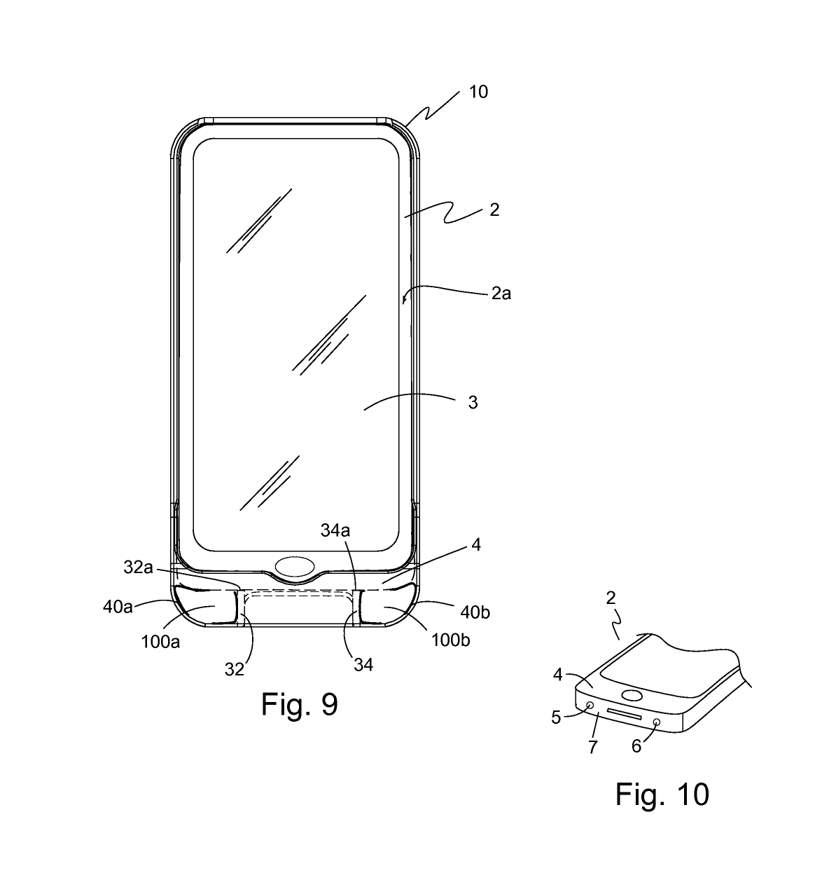

FIG. 3 illustrates a front view of case 10 with lower end portion 80. Front panel member 26 extends between top margin 14a of first sidewall 14, top margin 16a of second sidewall 16, and top margin 22a of lower end wall 22. Shown in broken lines in FIG. 3, a first intermediate wall 32 and a second intermediate wall 34 extend from lower end wall 22 a predefined distance 36 towards upper end wall 18. Predefined distance 36 in one embodiment is about ⅜ inch. In combination with other walls of case 10, first and second intermediate walls 32, 34 also define one or more filter compartments 40, as discussed in more detail below. Ends 32a, 34a of first and second intermediate walls 32, 34, respectively, provide a stop block or case surface 32a, 34a to prevent handheld wireless device 2 (shown in FIGS. 9-10) from occupying filter compartment(s) 40. Stated differently, ends 32a, 34a define a lower boundary 21a of device well 21 at lower end portion 80 of case 10. Thus, device well 21 (and handheld wireless device 2, when present) is separated from lower end wall 22 by predefined distance 36.

First sidewall 14 and/or second sidewall 16 optionally include a rim 15, 17 that extends along all or part of top margins 14a, 16a, respectively. Rims 15, 17 protrude inwardly from sidewalls 14, 16 at or near top margins 14a, 16a, respectively. Rims 15, 17 are useful to engage a top surface 2a of handheld wireless device 2 (shown in FIG. 9) to retain handheld wireless device 2 within case 10. First sidewall 14 and/or second sidewall 16 optionally include one or more ribs 13 (shown in FIG. 1) along all or part of inside surface thereof. Ribs 13 protrude inwardly from sidewalls 14, 16 and are useful to slightly offset handheld wireless device 2 from sidewalls 14, 16.

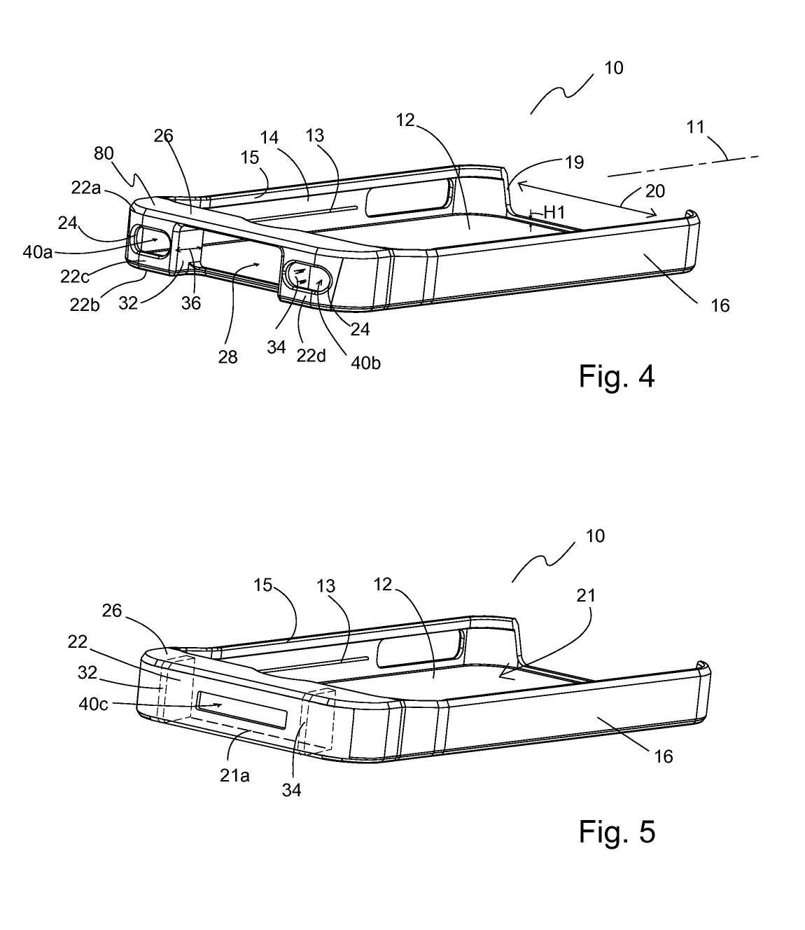

Turning now to FIG. 4, a lower end perspective view illustrates one embodiment of case 10 with first sidewall 14, second sidewall 16, and lower end portion 80. Rim 15 preferably extends along all or most of sidewall 14. In one embodiment, upper end wall 18 has an opening or cutout 19 through a major portion 20 of upper end wall 18 for access to control buttons and the like. In one embodiment designed for a phone, cutout 19 is approximately two inches wide and leaves a height H1 of about 1/16 inch for major portion 20 of upper end wall 18.

Lower end portion 80 of case 10 includes a lower end wall 22 with one or more openings 24 therethrough. Lower end wall 22 has a top margin 22a and a bottom margin 22b. Bottom margin 22b of lower end wall 22 extends along and connects to lower edge 12d of case body 12. A front panel member 26 extends between and connects top margin 14a of first sidewall 14, top margin 16a of second sidewall 16, and top margin 22a of lower end wall 22.

In some embodiments, such as shown in FIG. 4, lower end wall 22 has a left portion 22c and right a portion 22d separated by a cutout or connector opening 28. Connector opening 28 is useful, for example, to facilitate connecting cables to an end face 7 of handheld wireless device 2 (shown in FIG. 10).

First intermediate wall 32 and second intermediate wall 34 are positioned between first sidewall 14 and second sidewall 16 and extend from lower end wall 22 towards upper end wall 18 a predefined distance 36. First and second intermediate walls 32, 34 are preferably substantially perpendicular to first sidewall 14 and second sidewall 16, respectively. In other embodiments, first intermediate wall 32 and/or second intermediate wall 34 may be angled with respect to central longitudinal axis 11 to direct sound towards the device's built-in microphone.

One or more filter compartments 40 are defined by voids between a plurality of walls, including first sidewall 14, second sidewall 16, case body 12, front panel member 26, first intermediate wall 32, and second intermediate wall 34. Filter compartment(s) 40 are configured to receive a sound filter 100 (shown in FIG. 1) to break up or reduce the sound of moving air picked up by the microphone of handheld wireless device 2. Filter compartment(s) 40 are preferably enclosed on five sides and are open along lower boundary 21a (shown in FIG. 3) of device well 21 so that sound filter 100 may make direct contact with a device lower end portion 4 (shown in FIGS. 9-10). Device lower end portion 4 is the portion of handheld wireless device 2 that is generally positioned downward when the device is in use, such as in the case with a wireless phone.

In the embodiment of FIG. 4, for example, a first filter compartment 40a is defined between first intermediate wall 32, first sidewall 14, case body 12, first portion 22c of lower end wall 22, and front panel member 26. A second filter compartment 40b is defined between second intermediate wall 34, second sidewall 16, case body 12, second portion 22d of lower end wall 22, and front panel member 26. Second filter compartment 40b may house sound filter 100 for a second microphone or for a speaker of device 2.

Referring now to FIG. 5, another embodiment of case 10 has a filter compartment 40c defined between first intermediate wall 32, second intermediate wall 34, lower end wall 22, case body 12, and front panel member 26. In yet other embodiments, case 10 has no first or second intermediate wall 32, 34 and filter compartment 40c is defined between first sidewall 14, second sidewall 16, case body 12, lower end wall 22, and front panel member 26. In such an embodiment, first and second intermediate walls 32, 34 may be replaced by a protrusion, block, or other structure within lower end portion 80 that prevents handheld wireless device 2 from moving beyond lower boundary 21a of device well 21, and therefore from occupying filter compartment(s) 40.

Sound filter 100 in one embodiment is reticulated polyester foam with 80 pores per inch and with a preferred thickness of at least ⅜ inch between handheld wireless device 2 and the ambient air as measured along central longitudinal axis 11. Accordingly, in one embodiment, predefined distance 26 of filter compartment(s) 40 is about ⅜ inch. Reticulated foam has larger pores than other open-cell foams and therefore more effectively breaks up the sound of moving air without overly reducing the clarity of sound picked up by the device's built-in microphone. A filter thickness of less than ⅜ inch between handheld wireless device 2 and the ambient air may be used, but with reduced effectiveness. Sound filter 100 balances competing interests of effectively breaking up noise from moving air, keeping manufacturing costs low, having a small size, and maintaining clarity of sound reaching the device's built-in microphone. Depending on the controlling interest(s) of the user, many other materials and thicknesses of sound filter 100 are acceptable, such as soft open-cell foams (e.g., polyester or polyurethane) and layers or pieces of woven nylon fabric, tissue, cloth, neoprene foam (polychloroprene) and other sound dampening materials.

Sound filter(s) 100 is (are) preferably sized to fill filter compartment(s) 40. Preferably, sound filter(s) 100 are slightly larger than the actual dimensions of filter compartment(s) 40 so that sound filter(s) 100 must be compressed to fit within filter compartment(s) 40. The tendency to expand to its uncompressed state provides sufficient friction between sound filter 100 and walls of filter compartment 40 to retain sound filter 100 in position. By sizing the uncompressed dimension of sound filter 100 to tend to extend slightly beyond filter compartment 40 into device well 21, sound filter 100 fits snugly in contact with device lower end portion 4 of handheld wireless device 2 when handheld wireless device 2 is installed in case 10 (see FIG. 9). This snug fit enables sound filter 100 to abut handheld wireless device 2 at, near, or around microphone or microphone opening 5 (shown in FIG. 10). This abutment prevents moving air from reaching microphone or microphone opening 5 by substantially closing gaps between the ambient air and microphone or microphone opening 5.

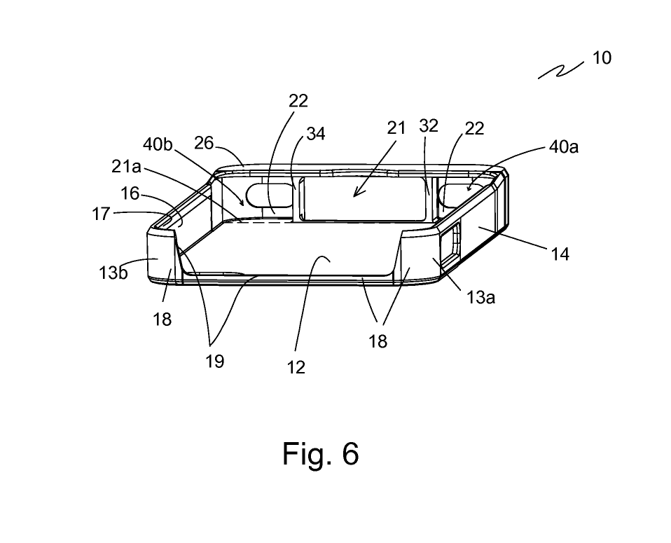

Referring now to FIG. 6, case 10 is shown as viewed looking at upper end wall 18 with cutout 19 between rounded corners 13a, 13b. First filter compartment 40a is defined between front panel cover 26, case body 12, first sidewall 14, first intermediate wall 32, and lower end wall 22. Second filter compartment 40b is defined between front panel cover 26, case body 12, second sidewall 16, second intermediate wall 34, and lower end wall 22. Rim 17 extends slightly inwardly from second sidewall 16 to facilitate retaining handheld wireless device 2 within case 10. Lower boundary 21a of device well 21 is shown in a broken line extending along first and second intermediate walls 32, 34.

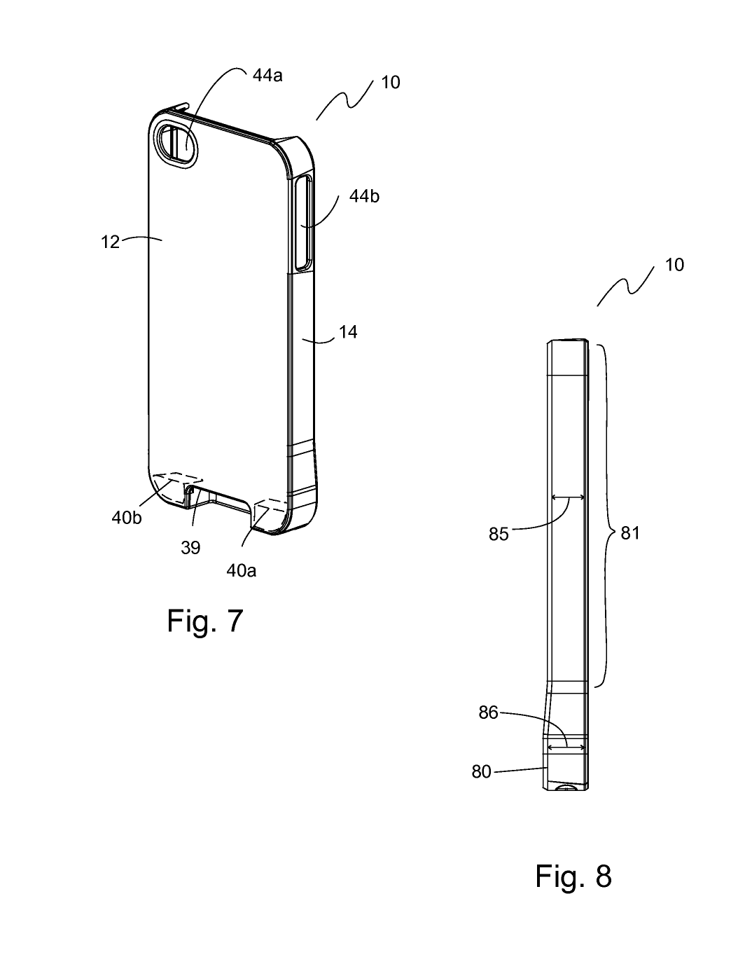

Referring now to FIG. 7, a rear perspective view illustrates the embodiment of case 10 shown in FIG. 1 with optional openings 44a, 44b through case body 12 and first sidewall 14, respectively. Lower end portion 80 has back cutout 39. Filter compartments 40a, 40b, shown in FIG. 7 in broken lines, are concealed by case body 12 on opposite lateral sides of back cutout 39.

FIG. 8 illustrates a side view of the embodiment of case 10 shown in FIG. 1. Lower end portion 80 has an end inside height 86 that is preferably greater than inside height 85 along a major portion 81 of case 10 above lower end portion 80. When case 10 is made of rigid materials, such as hard plastic, end inside height 86 being greater than inside height 85 allows handheld wireless device 2 to be inserted more easily into lower end portion 80. When case 10 is made of less rigid materials, such as rubber or flexible plastic, case 10 instead may be deformed or stretched to allow handheld wireless device 2 to be inserted into device well 21 (shown in FIG. 1) while also providing a snug fit between case 10 and handheld wireless device 2. In one embodiment, end inside height 86 of lower end portion 80 is about 9.6 mm (0.38 inch) as compared to inside height 85 of about 8.0 mm (0.32 inch). In embodiments of case 10 designed to accommodate handheld wireless device 2 having a built-in microphone located on the device front surface 2a, end inside height 86 of lower end portion may be further increased to allow sound filter 100 to occupy a position against device front surface 2a.

FIG. 9 illustrates a front view of one embodiment of case 10 with a handheld wireless device 2 installed in device well 21 (see FIG. 1). Handheld wireless device 2 has a device front surface 2a with a screen 3. A portion of handheld wireless device 2 is shown in FIG. 10 and has a microphone or microphone opening 5 and a speaker opening 6 on end face 7 of a device lower end portion 4. Device lower end portion 4 fits into and is partially concealed by case lower end portion 80. Device lower end portion 4 is retained in case 10 by front panel member 26 and abuts ends 32a, 34a of first and second intermediate walls 32, 34, respectively. Device lower end portion 4 also preferably abuts and slightly compresses sound filters 100a, 100b, which are biased to extend in an uncompressed state beyond filter compartments 40a, 40b, respectively. Accordingly, microphone opening 5 and speaker opening 6 abut sound filters 100 when installed in case 10 as shown in FIG. 9.

In use, case 10 enables the user to conduct a phone call or record sounds in a breezy environment with little or no sound interference caused by moving air against microphone or microphone opening 5. Sound filter(s) 100 may provide additional benefits, such as reducing sibilance and a general improvement in call clarity and audio recording or transmission. Embodiments of case 10 of the present invention may be adapted for use with a variety of handheld wireless devices and communication equipment, such as wireless phones, satellite phones, cell phones, cordless telephones, two-way radios, tablet computers, and the like.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A case for a handheld wireless device, the case comprising:
a case body defining a device well adapted to receive a handheld wireless device, the handheld wireless device having a microphone and a device lower end portion;
a filter compartment defined by a plurality of walls of the case body and positioned to be adjacent to the microphone when the handheld wireless device is received in the device well; and
a sound filter disposed in the filter compartment and configured to reduce sound received by the microphone due to moving air.

2. The case of claim 1, wherein the filter compartment is adjacent the device lower end portion and the sound filter is configured to abut the handheld wireless device proximate to the microphone.

3. The case of claim 1, wherein the sound filter comprises open-cell foam.

4. The case of claim 3, wherein the sound filter comprises reticulated foam.

5. The case of claim 1, wherein the sound filter has a thickness of at least ¼″ between the microphone and the ambient air.

6. The case of claim 1, wherein the sound filter is retained in the filter compartment by being compressed between the plurality of walls of the case body.

7. A case for a handheld wireless device comprising:
a case having a case upper end portion, a case lower end portion, and a body with a plurality of walls extending substantially perpendicularly from the body, the case defining a device well adapted to receive a handheld wireless device with a microphone in a device lower end portion;
a filter compartment defined by the case lower end portion and in communication with the device well; and
a sound filter disposed in the filter compartment, wherein the sound filter is configured to abut the device lower end portion to reduce the microphone from receiving sound caused by moving air.

8. The case of claim 7, wherein the sound filter comprises open-cell foam.

9. The case of claim 8, wherein the sound filter comprises reticulated foam.

10. The case of claim 7, wherein the sound filter has a thickness of at least ¼″ between the microphone and the ambient air.

11. The case of claim 7, wherein the sound filter is retained in the filter compartment by being maintained therein in a compressed state.

12. A kit for a handheld wireless device, the kit comprising:
a case with a body portion and a plurality of walls defining a device well adapted to receive a handheld wireless device with a microphone;
a filter compartment defined by a plurality of walls of the case body and positioned adjacent to the microphone when the handheld wireless device is received in the case body; and
a sound filter configured to be disposed in the filter compartment to reduce sound interference received by the microphone due to moving air.

13. The kit of claim 12, wherein the filter compartment is adjacent a device lower end portion of the handheld wireless device.

14. The kit of claim 12, wherein the sound filter comprises open-cell foam.

15. The kit of claim 14, wherein the sound filter comprises reticulated foam.

16. The kit of claim 12, wherein the sound filter has a thickness of at least ¼″ between the microphone and the ambient air.

17. The kit of claim 12, wherein the sound filter is configured to be retained in the filter compartment by being compressed between the plurality of walls of the case body.
